(19) United States
(12) Patent Application Publication
(10) Pub. No.: US 2026/0083109 A1
(43) Pub. Date: Mar. 26, 2026

(54) METHODS RELATED TO PUMPING FISH

(71) Applicant: SeaQuest Engineering Limited, Killybegs, Donegal (IE)

(72) Inventor: Brian Leslie, Killybegs, Co. Donegal (IE)

(73) Assignee: SeaQuest Engineering Limited, Killybegs, Co. Donegal (IE)

(21) Appl. No.: 19/111,112

(22) PCT Filed: Sep. 11, 2023
(86) PCT No.: PCT/EP2023/074880

§ 371 Date: Mar. 12, 2025

(30) Foreign Application Priority Data
Sep. 15, 2022 (NO) 20220979

(51) Int. Cl. A01K 79/00; B65G 53/30

(52) U.S. Cl. CPC A01K 79/00; B65G 53/30

(57) ABSTRACT

A method of reducing the quantity of fish being pumped by a fish pump whilst maintaining a sufficient flow rate such that fish cannot swim back upstream into the pump includes providing an apparatus having: a primary communication channel for delivery of water and fish therethrough; a fish pump having an inlet and an outlet and arranged on the primary communication channel and configured to pump water and fish along the primary communication channel; and an upstream bypass chamber arranged on the primary communication channel upstream of the fish pump inlet; wherein the upstream bypass chamber is configured to mix a flow of water into the primary communication channel; providing fish and water to the primary communication channel; operating the fish pump to pump the fish and water along the primary communication channel; and mixing a flow of water into the primary communication channel at the upstream bypass chamber.

### CROSS-REFERENCE TO RELATED APPLICATIONS

This application is the U.S. national stage application of International Application No. PCT/EP2023/074880, filed Sep. 11, 2023, which international application was published on Mar. 21, 2024, as WO 2024/056595 in the English language. The International Application claims priority to Norwegian Ser. No. 20/220,979 , filed Sep. 15, 2022. The international application and Norwegian application are both incorporated herein by reference, in their entirety.

### FIELD

The present invention relates to methods for pumping fish. More specifically, the invention relates to methods for pumping anadromous fish.

### BACKGROUND

In aquaculture, fish are often pumped between locations for various reasons. Fish may be pumped from one location to another to move the fish or to harvest the fish when they are fully grown. Furthermore, fish may be pumped onto a vessel for a delousing operation to be performed on the fish and then pumped back into the water to continue growing. The fish are typically pumped with the water within which they are living, i.e. the pump moves a volume of water and fish together.

During normal pumping of the fish, the fish pump will run at a normal operating speed. This results in a flow of water downstream of the pump which is at a normal output flow speed.

Should the operator or the process downstream require less or no fish to be pumped for a period of time, the pump must be switched to a slower speed of operation or stopped. This results in a flow of water downstream which is slower than the normal output flow speed.

If the fish being pumped are anadromous, i.e. they swim upstream, such as salmon, smelt and sturgeon, they may swim faster than the slowed output flow speed, and be able to swim back to the pump. This is highly undesirable, as it can cause damage to the fish and/or the pump, particularly when the pump speed is increased again.

Japanese patent document JPS6181321A discloses a solid material transfer device equipped with a rotary solid material transfer pump that urges the liquid with an impeller and transfers the solid material using the liquid as a transfer medium.

Japanese patent document JP355011474A discloses an apparatus for transporting solids such as fish using a liquid such as water as a transport medium. The disclosure relates to transferring the product with less damage. A pump is provided with a rotating impeller.

The invention has for its object to remedy or to reduce at least one of the drawbacks of the prior art, or at least provide a useful alternative to the prior art.

The object is achieved through features, which are specified in the description below and in the claims that follow.

### SUMMARY

According to a first aspect of the invention, there is provided a method of reducing the quantity of fish being pumped by a fish pump whilst maintaining a sufficient flow rate such that fish cannot swim back upstream into the pump, the method comprising the steps of: providing an apparatus for pumping fish, comprising: a primary communication channel for delivery of water and fish therethrough; a fish pump comprising an inlet and an outlet and arranged on the primary communication channel and configured to pump water and fish along the primary communication channel; and an upstream bypass chamber arranged on the primary communication channel upstream of the fish pump inlet; wherein the upstream bypass chamber is configured in use to mix a flow of water into the primary communication channel providing fish and water to the primary communication channel; operating the fish pump to pump the fish and water along the primary communication channel; mixing a flow of water into the primary communication channel at the upstream bypass chamber; thereby reducing the quantity of fish being pumped while maintaining a sufficient flow rate on the downstream side of the fish pump such that fish cannot swim back upstream to the fish pump outlet; characterised in that the upstream bypass chamber comprises a conical diffuser configured to slow the flow of water into the primary communication channel.

The fish pump may be a bladeless centrifugal pump.

The upstream bypass chamber may comprise a central fluid communication channel registered in diameter with the primary communication channel.

The central fluid communication channel may comprise grating configured to define an outer boundary within the upstream bypass chamber which the fish can reach as they pass through the upstream bypass chamber, whilst allowing water to enter the central fluid communication channel through the grating.

The spacing of the grating may be suitably sized such that fish being pumped through the upstream bypass chamber in use cannot pass through the grating and such that a sufficient volume of water can enter the central fluid communication channel through the grating.

The upstream bypass chamber may comprise an enlarged chamber configured to slow the flow of water into the primary communication channel.

The bypass chamber may comprise a fine grid configured to reduce the speed of the flow of water entering the bypass chamber to be mixed into the primary communication channel.

The primary communication channel may comprise first and second shut off valves configured to control the flow of water and fish in the primary communication channel.

The apparatus may further comprise a supplementary pump configured to pump water to the upstream bypass chamber.

The apparatus may further comprise a downstream bypass chamber arranged on the primary communication channel downstream of the fish pump outlet; wherein the downstream bypass chamber is configured in use to remove water from the primary communication channel such that the removed water can be recirculated to the upstream bypass chamber.

The apparatus may further comprise a supplementary pump configured to pump water from the downstream bypass chamber to the upstream bypass chamber.

According to a second aspect of the invention, there is provided a method of reducing the quantity of fish being pumped by a fish pump whilst maintaining a sufficient flow rate such that fish cannot swim back upstream into the pump, the method comprising the steps of: providing an apparatus for pumping fish, comprising: a primary communication channel for delivery of water and fish therethrough; a fish pump comprising an inlet and an outlet and arranged on the primary communication channel and configured to pump water and fish along the primary communication channel; and an upstream bypass chamber arranged on the primary communication channel upstream of the fish pump inlet; wherein the upstream bypass chamber is configured in use to mix a flow of water a downstream bypass chamber arranged on the primary communication channel downstream of the fish pump outlet; wherein the downstream bypass chamber is configured in use to remove water from the primary communication channel such that the removed water can be recirculated to the upstream bypass chamber into the primary communication channel; providing fish and water to the primary communication channel; operating the fish pump to pump the fish and water along the primary communication channel; removing water from the primary communication channel at the downstream bypass chamber; communicating the removed water from the downstream bypass chamber to the upstream bypass chamber; and mixing the removed water back into the primary communication channel at the upstream bypass chamber; thereby reducing the quantity of fish being pumped while maintaining a sufficient flow rate on the downstream side of the fish pump such that fish cannot swim back upstream to the fish pump outlet;
characterised in that the upstream bypass chamber comprises a conical diffuser configured to slow the flow of water into the primary communication channel.

The fish pump may be a bladeless centrifugal pump.

The upstream bypass chamber may comprise a central fluid communication channel registered in diameter with the primary communication channel.

The central fluid communication channel may comprises grating configured to define an outer boundary within the upstream bypass chamber which the fish can reach as they pass through the upstream bypass chamber, whilst allowing water to enter the central fluid communication channel through the grating.

The spacing of the grating may be suitably sized such that fish being pumped through the upstream bypass chamber in use cannot pass through the grating and such that a sufficient volume of water can enter the central fluid communication channel through the grating.

The upstream bypass chamber may comprise a conical diffuser configured to slow the flow of water into the primary communication channel.

The upstream bypass chamber may comprise an enlarged chamber configured to slow the flow of water into the primary communication channel.

The bypass chamber may comprise a fine grid configured to reduce the speed of the flow of water entering the bypass chamber to be mixed into the primary communication channel.

The primary communication channel may comprise first and second shut off valves configured to control the flow of water and fish in the primary communication channel.

The apparatus may further comprise a supplementary pump configured to pump water to the upstream bypass chamber.

The apparatus may further comprise a supplementary pump configured to pump water from the downstream bypass chamber to the upstream bypass chamber.

### BRIEF DESCRIPTION OF THE DRAWINGS

An embodiment of the invention will now be described with reference to the following drawings, in which:

FIG. 1 shows a hydraulics diagram of an apparatus for pumping fish;

FIG. 2 shows a bypass valve used in the apparatus of FIG. 1; and

FIG. 3 shows a hydraulics diagram of an alternative example of an apparatus for pumping fish.

For clarity reasons, some elements may in some of the figures be without reference numerals. A person skilled in the art will understand that the figures are just principal drawings. The relative proportions of individual elements may also be distorted.

### DETAILED DESCRIPTION OF THE DRAWINGS

In the following description, all of the fluid communication connections are not described in detail in the interest of brevity. It is assumed that the skilled person is capable of understanding the fluid connections from the drawings without further explanation.

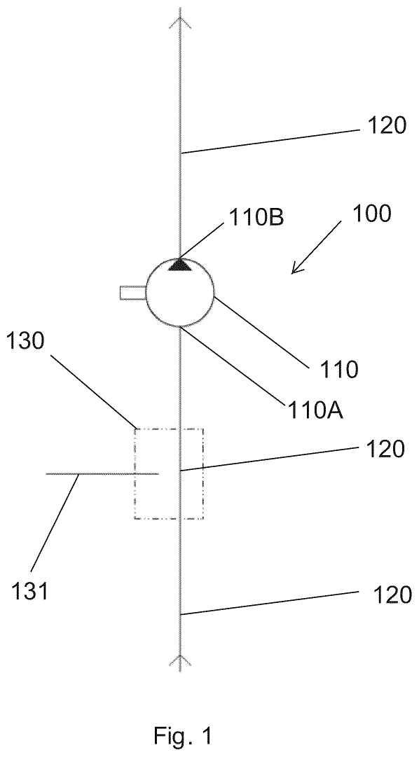

FIG. 1 shows an example apparatus 100 for pumping anadromous fish. The apparatus 100 comprises a fish pump 110 comprising an inlet 110A and an outlet 110B. The fish pump 110 in the presently described example is a bladeless centrifugal pump. However, it will be understood that other suitable designs of pump may be used such as, but not limited to, coanda or paddlewheel pumps. The fish pump 110 is configured to pump water and fish on a primary communication channel 120. The primary communication channel 120 is a series of pipes suitable for transporting fish therein. The primary communication channel 120 is connected to an upstream bypass chamber 130, the purpose and structure of which will be explained in more detail later.

Still referring to FIG. 1, fish and water are provided to the primary communication channel 120 on the inlet 110A side of the pump and are pumped by the pump 110 to continue on the primary communication channel 120 on the outlet 110B side of the pump 110.

If the downstream process requires fewer fish, or the operator decides to reduce the flow of fish through the pump 110, additional water can be provided to the pump 110 by mixing additional water with the fish and water in the primary communication channel 120 on the inlet 110A side of the pump. Said mixing is performed in the upstream bypass chamber 130.

In this connection, additional water is provided and flows to the primary communication channel 120 along a bypass communication channel 131. To enhance the flow of water along the bypass communication channel 131, water may be pumped along the bypass communication channel 131 by a suitably arranged pump (not shown in FIG. 1). It will be understood that the water may be provided without the use of a pump. For example, the water may be provided from a water reservoir located at a location physically higher than the bypass chamber, thereby utilising hydrostatic pressure to provide mixing of the water into the flow in the primary communication channel 120.

When additional water is provided to the pump 110 as presently described, the quantity of fish being pumped will be reduced if the pump 110 is maintained at the same pumping speed. This allows the speed of water flow at the outlet 110B to be maintained regardless of the quantity of fish being pumped.

Said another way, in the example above, the pump 110 is initially provided with water and fish and set at an operating speed. This results in a water flow at the outlet 110B of a particular speed. If the pump 110 were to be slowed to reduce the quantity of fish being pumped, the speed of the water flow at the outlet 110B would be reduced. If the speed of the water flow at the outlet drops sufficiently, anadromous fish may be able to swim back towards the pump outlet 110B, potentially causing damage to the pump 110 and/or the fish.

However, as described above, by providing additional water to the primary communication channel 120 on the inlet 110A side of the pump 110, the quantity of fish pumped is reduced whilst the flow rate at the outlet 110B is maintained. This ensures that the flow rate at the outlet 110B can be maintained sufficiently high such that fish cannot swim back to the outlet 110B.

It will be understood that the upstream bypass chamber 130 may be any suitable connection between the bypass communication channel 131 and the primary communication channel 120 such that the flow of water in the bypass communication channel 131 can be mixed with the flow of water and fish in the primary communication channel 120.

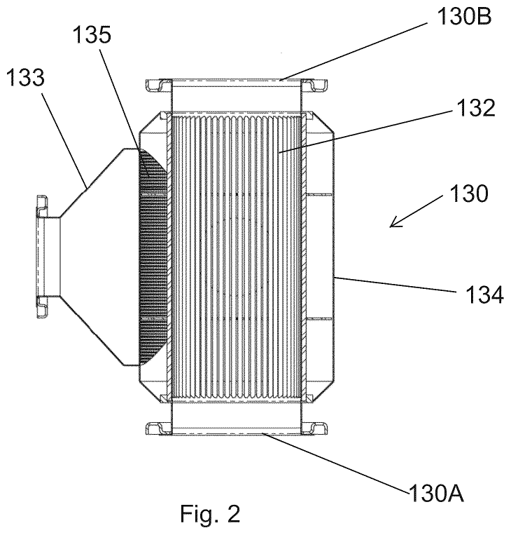

Referring now to FIG. 2, further details of a preferred upstream bypass chamber 130 can be seen. As previous discussed, the upstream bypass chamber 130 is arranged in line on the primary communication channel 120. In this regard, the inlet 130A and outlet 130B are connected to the primary communication channel 120. Within the upstream bypass chamber 130, there is provided a central fluid communication channel 132 that, when the upstream bypass chamber 130 is assembled in the primary communication channel 120, provides a continuation of the primary communication channel 120 such that fish can enter the upstream bypass chamber 130 at the inlet 130A and exit at the outlet 130B. In this connection, the central fluid communication channel 132 is registered in diameter with the diameter of the primary communication channel 120. That is to say, they have the same or substantially similar diameters.

The upstream bypass chamber 130 also comprises a conical diffuser 133 arranged to be fluidly connected to the bypass communication channel 131. The purpose of the conical diffuser 133 is to slow the flow of water from the bypass communication channel 131 as it enters the upstream bypass chamber 130 to prevent stress to the fish within the central fluid communication channel 132.

In this connection, it is highly desirable that the flow of water from the bypass communication channel 131 mixes smoothly with the flow of water in the central fluid communication channel 132. To this end, the upstream bypass chamber 130 comprises an enlarged chamber 134 into which the flow from the conical diffuser 133 arrives. The central fluid communication channel 132 is provided with a grating defining the outer boundary that the fish can reach within the central fluid communication channel 132, whilst allowing water to enter the central fluid communication channel 132 from the enlarged chamber 134. It will be understood that the spacing of the grating must be sufficiently small such that fish being pumped cannot pass through the grating. However, the spacing of the grating must be sufficiently large such that a sufficient volume of water can enter the central fluid communication channel 132 from the enlarged chamber 134.

Still referring to FIG. 2, the upstream bypass chamber 130 comprises a further flow reduction mechanism located between the conical diffuser 133 and the enlarged chamber 134. The further flow reduction mechanism is a fine grid 135 which further reduces the speed of the water entering the enlarged chamber 134 from the conical diffuser 133.

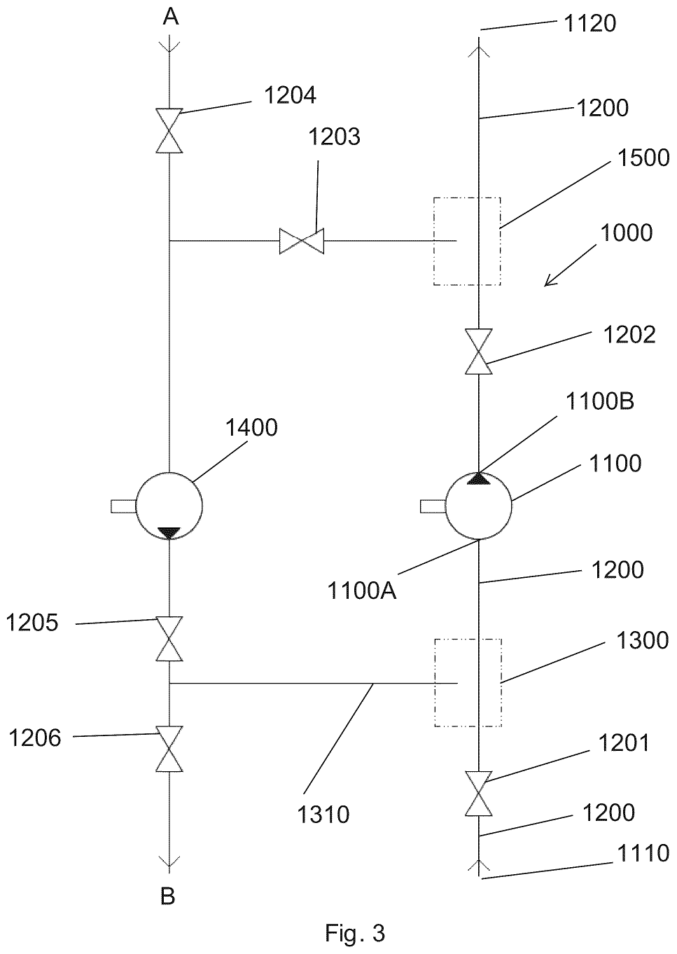

FIG. 3 shows an alternative apparatus 1000 for pumping anadromous fish. Like reference numerals to the example shown in FIGS. 1 and 2 are used to indicate like items in FIG. 3, with the addition of ‘0’. For example, the pump 110 in the example in FIGS. 1 and 2 is labelled 1100 in FIG. 3.

The apparatus 1000 comprises a fish pump 1100 comprising an inlet 1100A and an outlet 1100B. As in the previously described example, the fish pump 1100 in the presently described example is a bladeless centrifugal pump. However, it will be understood that other suitable designs of pump may be used such as, but not limited to, coanda or paddlewheel pumps. The fish pump 1100 is configured to pump water and fish on a primary communication channel 1200 from a fish start point 1110 to a fish end point 1120. The primary communication channel 1200 is a series of pipes suitable for transporting fish therein.

As can be seen in FIG. 3, the primary communication channel 1200 is provided with first and second shut off valves 1201, 1202. These are provided to allow control of the flow within the primary communication channel 1200. Depending on the type of pump 1100 used in other examples, the first and second shut off valves 1201, 1202 may not be required. For example, vacuum pumps (push-pull) or injector pumps (Coanda type) may not require the first and second shut off valves 1201, 1202.

The primary communication channel 1200 is connected to an upstream bypass chamber 1300. Fish and water are provided to the primary communication channel 1200 on the inlet 1100A side of the pump 1100 and are pumped by the pump 1100 to continue on the primary communication channel 1200 on the outlet 1100B side of the pump 1100.

Additional water can be provided to the pump 1100 by mixing additional water with the fish and water in the primary communication channel 1200 on the inlet 1100A side of the pump. Said mixing is performed in the upstream bypass chamber 1300. Additional water is provided and flows to the primary communication channel 1200 along a bypass communication channel 1310.

To enhance the flow of water along the bypass communication channel 1310, water is pumped along the bypass communication channel 1310 by a supplementary pump 1400. Again, it will be understood that in some alternative examples a supplementary pump 1400 may not be necessary.

The apparatus 1000 comprises a plurality of shut off valves arranged at various locations. In this connection, there is provided third 1203, fourth 1204, fifth 1205 and sixth 1206 shut off valves in the presently described example. It will be understood that, depending on the specific arrangement and desired functionality, more or fewer shut off valves may be provided in other examples.

Still referring to FIG. 3, the third and fourth shut off valves 1203, 1204 are provided to select of the source of water to the supplementary pump 1400. In this connection, the fourth shut off valve 1204, when opened, provides delivery of water from a supplementary water source A to the supplementary pump 1400.

Alternatively, water may be provided to the supplementary pump 1400 from near the outlet 1100B of the fish pump 1100. In this connection, some water is sucked by the pump 1400 from the primary communication channel 1200 at a downstream bypass chamber 1500. In the presently described example, the downstream bypass chamber 1500 is structurally the same as the upstream bypass chamber 1300, i.e. both the upstream and downstream bypass chambers 1300, 1500 are as shown in FIG. 2. However, the downstream bypass chamber 1500 is arranged in the apparatus 1000 such that water is removed from the primary communication channel 1200 at the downstream bypass chamber 1500 rather than added to the primary communication channel 1200, as at the upstream bypass chamber 1300.

Although in the presently described example, the upstream and downstream bypass chambers 1300, 1500 are structurally the same, this is not critical. That is to say, in alternative examples, the upstream bypass chamber 1300 may be structurally different from the downstream bypass chamber 1500.

By providing the downstream bypass chamber 1500, as can be seen in FIG. 3, a fluid flow loop from the outlet 1100B of the fish pump 1100 back to the inlet 1100A can be formed. If the downstream operation or the operator does not require fish for a period of time, the downstream bypass chamber 1500 and supplementary pump 1400 can be used to circulate water back to the primary communication channel 1200. In this mode of operation, the third 1203 and fifth 1205 shut off valves are opened and the supplementary pump 1400 is operated. An opened third shut off valve 1203 provides fluid communication between the downstream bypass chamber 1500 and the supplementary pump 1400. An opened fifth shut off valve 1205 provides fluid communication between the supplementary pump 1400 and the upstream bypass chamber 1300, therefore regardless of the water supply being from source A or the downstream bypass chamber 1500, the fifth shut off valve 1205 needs to be open for the supplementary pump 1400 to pump water to the upstream bypass chamber 1300.

A continuous loop of very fast flowing water from the outlet 1100B to the inlet 1100A results in the fish pump 1100 not taking any fish from upstream of the upstream bypass chamber 1300, i.e. the fish start point 1110, as the entire pumping capacity (volume) of the fish pump 1100 is consumed by pumping the recirculated water. Most importantly, during said recirculation, the speed of flow of water in the primary communication channel 1200 at the outlet of the pump 1100B, i.e. between the outlet 1100B and the downstream bypass chamber 1500, is maintained sufficiently high such that fish cannot swim upstream to the pump. This therefore allows the operator to halt the flow of fish through the pump whilst maintaining a sufficiently high flow of water only, such that fish downstream of the pump cannot swim back upstream and reach the pump, which as described above can cause damage to the pump and/or the fish.

It will be understood that the fluid flow loop from the outlet 1100B of the fish pump 1100 back to the inlet 1100A can also be used to simply reduce the quantity of fish being pumped, rather than to stop fish being pumped completely. The volumetric flow rate required of the supplementary pump 1400 to stop the flow of fish into the fish pump 1100 will depend on the specification and configuration of the fish pump 1100 and the apparatus 1000 as a whole, i.e. the pipe dimensions etc. Similarly, the volumetric flow rate required of the supplementary pump 1400 to reduce the quantity of fish being pumped will also depend on the specification and configuration of the fish pump 1100 and the apparatus 1000 as a whole, i.e. the pipe dimensions etc.

Still referring to FIG. 3, the sixth shut off valve 1206 can be used to eject water from the apparatus 1000 to point B. This may be used if the apparatus 1000 is being cleaned for example. Alternatively, if there is a malfunction and water should be ejected from the apparatus 1000, the sixth shut off valve 1206 may be opened to allow an exit path for the water. Alternatively, point B may in some examples be another water source, with the sixth shut off valve being opened to provide fluid communication between this alternative water source and the upstream bypass valve 1300.

As previously discussed, the downstream bypass chamber 1500 may be similar or identical to the upstream bypass chamber 1300. In this connection, the physical features of the upstream bypass chamber 1300 are also present in the downstream bypass chamber 1500.

That is to say, the downstream bypass chamber 1500 also comprises a conical diffuser, an enlarged chamber and a fine grid (not shown in FIG. 3). However, since the downstream bypass chamber 1500 is operating in the opposite sense to the upstream bypass chamber 1300, i.e. the downstream bypass chamber 1500 is removing water from the primary communication channel 1200 rather than adding water thereto, the purpose of the conical diffuser, enlarged chamber and fine grid are to allow the water to be removed from the primary communication channel 1200 with a slow flow speed. The conical diffuser then accelerates the flow as it narrows the flow area to the diameter of the pipe work through which the flow must pass in the circulation loop.

It is highly advantageous to remove water with a slow flow speed at the primary communication channel 1200, as a high-speed flow of water out of the primary communication channel 1200 would result in the fish being sucked towards the supplementary pump 1400 when the fish are in the downstream bypass chamber 1500. This may, in some examples, cause a blockage at the downstream bypass chamber 1500 and therefore affect the performance of the apparatus 1000. Additionally, or alternatively, sucking the fish towards the supplementary pump 1400 within the downstream bypass chamber 1500 may cause stress to the fish, which is highly undesirable.

### Clauses

Clause 1. A method of reducing the quantity of fish being pumped by a fish pump whilst maintaining a sufficient flow rate such that fish cannot swim back upstream into the pump, the method comprising the steps of:
providing an apparatus (100, 1000) for pumping fish, comprising:
   a primary communication channel (120, 1200) for delivery of water and fish therethrough;
   a fish pump (110, 1100) comprising an inlet (110A, 1100A) and an outlet (110B, 1100B) and arranged on the primary communication channel (120, 1200) and configured to pump water and fish along the primary communication channel (120, 1200); and
   an upstream bypass chamber (130, 1300) arranged on the primary communication channel (120, 1200) upstream of the fish pump inlet (110A, 1100A);
wherein the upstream bypass chamber (130, 1300) is configured in use to mix a flow of water into the primary communication channel (120, 1200) providing fish and water to the primary communication channel (120, 1200);
operating the fish pump (110, 1100) to pump the fish and water along the primary communication channel (120, 1200);
mixing a flow of water into the primary communication channel (120, 1200) at the upstream bypass chamber (130, 1300);
thereby reducing the quantity of fish being pumped while maintaining a sufficient flow rate on the downstream side of the fish pump (110, 1100) such that fish cannot swim back upstream to the fish pump outlet (110B, 1100B);
characterised in that the upstream bypass chamber (130, 1300) comprises a conical diffuser (133) configured to slow the flow of water into the primary communication channel (120, 1200).

Clause 2. The method according to clause 1, wherein the fish pump (110, 1100) is a bladeless centrifugal pump.

Clause 3. The method according to clause 1 or 2, wherein the upstream bypass chamber (130, 1300) comprises a central fluid communication channel (132) registered in diameter with the primary communication channel (120, 1200).

Clause 4. The method according to clause 3, wherein the central fluid communication channel (132) comprises grating configured to define an outer boundary within the upstream bypass chamber (130, 1300) which the fish can reach as they pass through the upstream bypass chamber (130, 1300), whilst allowing water to enter the central fluid communication channel (132) through the grating.

Clause 5. The method according to clause 4, wherein the spacing of the grating is suitably sized such that fish being pumped through the upstream bypass chamber (130, 1300) in use cannot pass through the grating and such that a sufficient volume of water can enter the central fluid communication channel (132) through the grating.

Clause 6. The method according to any preceding clause, wherein the upstream bypass chamber (130, 1300) comprises an enlarged chamber (134) configured to slow the flow of water into the primary communication channel (120, 1200).

Clause 7. The method according to any preceding clause, wherein the bypass chamber (130, 1300) comprises a fine grid configured to reduce the speed of the flow of water entering the bypass chamber (130, 1300) to be mixed into the primary communication channel (120, 1200).

Clause 8. The method according to any preceding clause, wherein the primary communication channel (1200) comprises first (1201) and second (1202) shut off valves configured to control the flow of water and fish in the primary communication channel (1200).

Clause 9. The method according to any preceding clause, wherein the apparatus (1000) further comprises a supplementary pump (1400) configured to pump water to the upstream bypass chamber (1300).

Clause 10. The method according to any of clauses 1 to 9, wherein the apparatus (1000) further comprises a downstream bypass chamber (1500) arranged on the primary communication channel (1200) downstream of the fish pump outlet (1100B);
wherein the downstream bypass chamber (1500) is configured in use to remove water from the primary communication channel (1200) such that the removed water can be recirculated to the upstream bypass chamber (1300).

Clause 11. The method according to clause 10, wherein the apparatus (1000) further comprises a supplementary pump (1400) configured to pump water from the downstream bypass chamber (1500) to the upstream bypass chamber (1300).

Clause 12. A method of reducing the quantity of fish being pumped by a fish pump (1100) whilst maintaining a sufficient flow rate such that fish cannot swim back upstream into the pump (1100), the method comprising the steps of:
providing an apparatus (1000) for pumping fish, comprising:
   a primary communication channel (1200) for delivery of water and fish therethrough;
   a fish pump (1100) comprising an inlet (1100A) and an outlet (1100B) and arranged on the primary communication channel (1200) and configured to pump water and fish along the primary communication channel (1200); and
   an upstream bypass chamber (1300) arranged on the primary communication channel (1200) upstream of the fish pump inlet (1100A);
wherein the upstream bypass chamber (1300) is configured in use to mix a flow of water a downstream bypass chamber (1500) arranged on the primary communication channel (1200) downstream of the fish pump outlet (1100B);
wherein the downstream bypass chamber (1500) is configured in use to remove water from the primary communication channel (1200) such that the removed water can be recirculated to the upstream bypass chamber (1300) into the primary communication channel (1200); providing fish and water to the primary communication channel (1200);
operating the fish pump (1100) to pump the fish and water along the primary communication channel (1200);
removing water from the primary communication channel (1200) at the downstream bypass chamber (1500);
communicating the removed water from the downstream bypass chamber (1500) to the upstream bypass chamber (1300); and
mixing the removed water back into the primary communication channel (1200) at the upstream bypass chamber (1300);
thereby reducing the quantity of fish being pumped while maintaining a sufficient flow rate on the downstream side of the fish pump (1100) such that fish cannot swim back upstream to the fish pump outlet (1100B);
characterised in that the upstream bypass chamber (1300) comprises a conical diffuser (133) configured to slow the flow of water into the primary communication channel (1200).

Clause 13. The method according to clause 12, wherein the fish pump (1100) is a bladeless centrifugal pump.

Clause 14. The method according to clause 12 or 13, wherein the upstream bypass chamber (1300) comprises a central fluid communication channel (132) registered in diameter with the primary communication channel (1200).

Clause 15. The method according to any of clauses 12 to 14, wherein the central fluid communication channel (132) comprises grating configured to define an outer boundary within the upstream bypass chamber (1300) which the fish can reach as they pass through the upstream bypass chamber (1300), whilst allowing water to enter the central fluid communication channel (1200) through the grating.

Clause 16. The method according to any of clauses 12 to 15, wherein the spacing of the grating is suitably sized such that fish being pumped through the upstream bypass chamber (1300) in use cannot pass through the grating and such that a sufficient volume of water can enter the central fluid communication channel (1200) through the grating.

Clause 17. The method according to any of clauses 12 to 16, wherein the upstream bypass chamber (1300) comprises an enlarged chamber configured to slow the flow of water into the primary communication channel (1200).

Clause 18. The method according to any of clauses 12 to 16, wherein the bypass chamber (1300) comprises a fine grid configured to reduce the speed of the flow of water entering the bypass chamber (1300) to be mixed into the primary communication channel (1200).

Clause 19. The method according to any of clauses 12 to 18, wherein the primary communication channel (1200) comprises first (1201) and second (1202) shut off valves configured to control the flow of water and fish in the primary communication channel (1200).

Clause 20. The method according to any of clauses 12 to 19, wherein the apparatus (1000) further comprises a supplementary pump (1400) configured to pump water to the upstream bypass chamber (1300).

Clause 21. The method according to any of clauses 12 to 20, wherein the apparatus (1000) further comprises a supplementary pump (1400) configured to pump water from the downstream bypass chamber (1500) to the upstream bypass chamber (1300).

1-23. (canceled)

24. A method of reducing a quantity of fish being pumped by a fish pump whilst maintaining a sufficient flow rate such that fish cannot swim back upstream into the fish pump, the method comprising the steps of:
providing an apparatus for pumping fish, comprising:
a primary communication channel for delivery of water and fish therethrough;
a fish pump comprising an inlet and an outlet and arranged on the primary communication channel and configured to pump water and fish along the primary communication channel; and
an upstream bypass chamber arranged on the primary communication channel upstream of the inlet of the fish pump;
wherein the upstream bypass chamber is configured in use to mix a flow of water into the primary communication channel providing fish and water to the primary communication channel;
operating the fish pump to pump the fish and water along the primary communication channel;
mixing a flow of water into the primary communication channel at the upstream bypass chamber;
thereby reducing the quantity of fish being pumped while maintaining a sufficient flow rate on a downstream side of the fish pump such that the fish cannot swim back upstream to the outlet of the fish pump;
wherein the upstream bypass chamber comprises a conical diffuser configured to slow the flow of water into the primary communication channel.

25. The method according to claim 24, wherein the fish pump is a bladeless centrifugal pump.

26. The method according to claim 24, wherein the upstream bypass chamber comprises a central fluid communication channel registered in diameter with the primary communication channel.

27. The method according to claim 26, wherein the central fluid communication channel comprises grating configured to define an outer boundary within the upstream bypass chamber which the fish can reach as they pass through the upstream bypass chamber, whilst allowing water to enter the central fluid communication channel through the grating.

28. The method according to claim 27, wherein a spacing of the grating is suitably sized such that the fish being pumped through the upstream bypass chamber in use cannot pass through the grating and such that a sufficient volume of water can enter the central fluid communication channel through the grating.

29. The method according to claim 24, wherein the upstream bypass chamber comprises an enlarged chamber configured to slow the flow of water into the primary communication channel.

30. The method according to claim 24, wherein the upstream bypass chamber comprises a fine grid configured to reduce the speed of the flow of water entering the upstream bypass chamber to be mixed into the primary communication channel.

31. The method according to claim 24, wherein the primary communication channel comprises first and second shut off valves configured to control the flow of water and fish in the primary communication channel.

32. The method according to claim 24, wherein the apparatus further comprises a supplementary pump configured to pump water to the upstream bypass chamber.

33. The method according to any of claims 24, wherein the apparatus further comprises a downstream bypass chamber arranged on the primary communication channel downstream of the outlet of the fish pump;
wherein the downstream bypass chamber is configured in use to remove water from the primary communication channel such that the water can be recirculated to the upstream bypass chamber.

34. The method according to claim 33, wherein the apparatus further comprises a supplementary pump configured to pump water from the downstream bypass chamber (1500) to the upstream bypass chamber.

35. A method of reducing a quantity of fish being pumped by a fish pump whilst maintaining a sufficient flow rate such that fish cannot swim back upstream into the fish pump, the method comprising the steps of:
providing an apparatus for pumping fish, comprising:
a primary communication channel for delivery of water and fish therethrough;
a fish pump comprising an inlet and an outlet and arranged on the primary communication channel and configured to pump water and fish along the primary communication channel; and
an upstream bypass chamber arranged on the primary communication channel upstream of the inlet of the fish pump;
wherein the upstream bypass chamber is configured in use to mix a flow of water a downstream bypass chamber arranged on the primary communication channel downstream of the outlet of the fish pump;
wherein the downstream bypass chamber is configured in use to remove water from the primary communication channel such that the water can be recirculated to the upstream bypass chamber into the primary communication channel;
providing fish and water to the primary communication channel;
operating the fish pump to pump the fish and water along the primary communication channel;
removing water from the primary communication channel at the downstream bypass chamber;
communicating the water from the downstream bypass chamber to the upstream bypass chamber; and
mixing the water back into the primary communication channel at the upstream bypass chamber;
thereby reducing the quantity of fish being pumped while maintaining a sufficient flow rate on a downstream side of the fish pump such that the fish cannot swim back upstream to the outlet of the fish pump;
wherein the upstream bypass chamber comprises a conical diffuser configured to slow the flow of water into the primary communication channel.

36. The method according to claim 35, wherein the fish pump is a bladeless centrifugal pump.

37. The method according to claim 35, wherein the upstream bypass chamber comprises a central fluid communication channel registered in diameter with the primary communication channel.

38. The method according to claim 35, wherein the primary fluid communication channel comprises grating configured to define an outer boundary within the upstream bypass chamber which the fish can reach as they pass through the upstream bypass chamber, whilst allowing water to enter the primary fluid communication channel through the grating.

39. The method according to claim 38, wherein a spacing of the grating is suitably sized such that the fish being pumped through the upstream bypass chamber in use cannot pass through the grating and such that a sufficient volume of water can enter the primary fluid communication channel through the grating.

40. The method according to claim 35, wherein the upstream bypass chamber comprises an enlarged chamber configured to slow the flow of water into the primary communication channel.

41. The method according to claim 35, wherein the upstream bypass chamber comprises a fine grid configured to reduce the speed of the flow of water entering the upstream bypass chamber to be mixed into the primary communication channel.

42. The method according to claim 35, wherein the apparatus further comprises a supplementary pump configured to pump water to the upstream bypass chamber.

43. The method according to claim 35, wherein the apparatus further comprises a supplementary pump configured to pump water from the downstream bypass chamber to the upstream bypass chamber.
